(19) United States
(12) Patent Application Publication
(10) Pub. No.: US 2014/0153656 A1
(43) Pub. Date: Jun. 5, 2014

(54) INTERFERENCE MITIGATION FOR CLOCK SIGNAL TRANSMISSIONS

(71) Applicants: Hao-Han Hsu, Portland, OR (US); Dong-Ho Han, Beaverton, OR (US); Chung-Hao J. Chen, Portland, OR (US)

(72) Inventors: Hao-Han Hsu, Portland, OR (US); Dong-Ho Han, Beaverton, OR (US); Chung-Hao J. Chen, Portland, OR (US)

(21) Appl. No.: 13/690,720

(22) Filed: Nov. 30, 2012

(51) Int. Cl. H04L 25/02

(52) U.S. Cl. CPC H04L 25/02
USPC 375/259; 375/295; 375/316

(57) ABSTRACT

Methods and systems may provide for generating a data signal based on a local clock signal and converting the local clock signal into a pseudorandom binary sequence (PRBS) signal. The data signal and the PRBS signal may be transferred from a transmitter to a receiver via a channel, wherein a recovered clock signal may be generated at the receiver based on the PRBS signal. Additionally, the data signal may be processed based on the recovered clock signal. In one example, the PRBS signal has a number of timing edges that is randomized and less than a number of timing edges in the local clock signal per period of time.

### BACKGROUND

1. Technical Field

Embodiments generally relate to interference mitigation. More particularly, embodiments relate to interference mitigation for clock signal transmissions.

2. Discussion

Clock signals have traditionally been an integral component of sequential digital circuits and can be widely found on personal computer (PC) platforms. For example, clock signals may be transmitted on a computing platform between dual data rate (DDR) memory and processors via planar transmission lines of a printed circuit board (PCB) on a motherboard, transmitted between video components via cables according to protocols such as HDMI (High-Definition Multimedia Interface, e.g., HDMI Specification, Ver. 1.3a, Nov. 10, 2006, HDMI Licensing, LLC), and so forth. Indeed, clock forwarding may be particularly useful in video data streaming because its circuit implementation can be much simpler compared to embedded clock implementations.

Typically, clock signals are composed of periodic square pulses with relatively sharp transitions and high slew-rates. This kind of signal may have very narrow peaks of high voltage levels in the frequency domain, and the high-order harmonics (order >20) of conventional clock signals can contain a significant amount of energy. Accordingly, both planar transmission lines and cables may emit radiated noise, and give rise to electromagnetic interference (EMI) and radio frequency interference (RFI) concerns, particularly as clock frequencies reach the giga-hertz range and beyond.

While passive efforts (e.g., metal shielding, stripline, twisted pair, common-mode choke, and decoupling components) and active efforts (e.g., spread-spectrum clocking/SSC, differential clocking, frequency down-conversion) have been made to reduce EMI/RFI issues on PC platforms, there remains considerable room for improvement. For example, conventional techniques typically may reduce noise by only about 5-15 dB. Indeed, even with the aforementioned techniques, long distance clock forwarding can cause substantial EMI/RFI issues. For example, many EMI issues in HDMI communications can be experienced even though metal shielded twisted pairs and other mitigation techniques may have been implemented. Moreover, some mitigation techniques can cause additional concerns. For example, frequency down-conversion may also introduce jitter.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of a clock forwarding link according to an embodiment;

FIGS. 2A and 2B are time domain plots of an example of a clock signal and a corresponding PRBS signal according to an embodiment;

FIGS. 3A and 3B are frequency domain plots of an example of a clock signal and a corresponding PRBS signal according to an embodiment;

FIG. 4 is a block diagram of an example of a conversion module according to an embodiment;

FIG. 5 is a block diagram of an example of a clock recovery module according to an embodiment;

FIG. 6 is a timing diagram of an example of a set of signals in a clock recovery module according to an embodiment;

FIG. 7 is a plot of an example of a clock recovery locking process according to an embodiment; and

FIG. 8 is a block diagram of an example of a platform according to an embodiment.

### DETAILED DESCRIPTION

Embodiments may include a transmitter having a data module to generate a data signal based on a clock signal, and a conversion module to convert the local clock signal into a pseudorandom binary sequence (PRBS) signal. The transmitter may also have a channel interface to send the data signal and the PRBS signal to a receiver via a channel.

Embodiments may also include a receiver having a channel interface to receive a data signal and a PRBS signal from a channel. Additionally, the receiver can have a clock recovery module to generate a recovered clock based on the PRBS signal and a data module to process the data signal based on the recovered clock.

Embodiments may also include a system having a channel and a transmitter with a first data module to generate a data signal based on a local clock signal. The transmitter may also include a conversion module to convert the local clock signal into a PRBS signal and a first channel interface to send the data signal and the PRBS signal via the channel. Additionally, the system can have a receiver with a second channel interface to receive the data signal and the PRBS signal from the channel, and a clock recovery module to generate a recovered clock based on the PRBS. The receiver may also include a second data module to process the data signal based on the recovered clock.

Embodiments may also include a method in which a data signal is generated based on a local clock signal. The method may also provide for converting the local clock signal into a PRBS signal, transferring the data signal and the PRBS signal from a transmitter to a receiver via a channel, and generating a recovered clock signal at the receiver based on the PRBS signal. Additionally, the data signal may be processed based on the recovered clock signal.

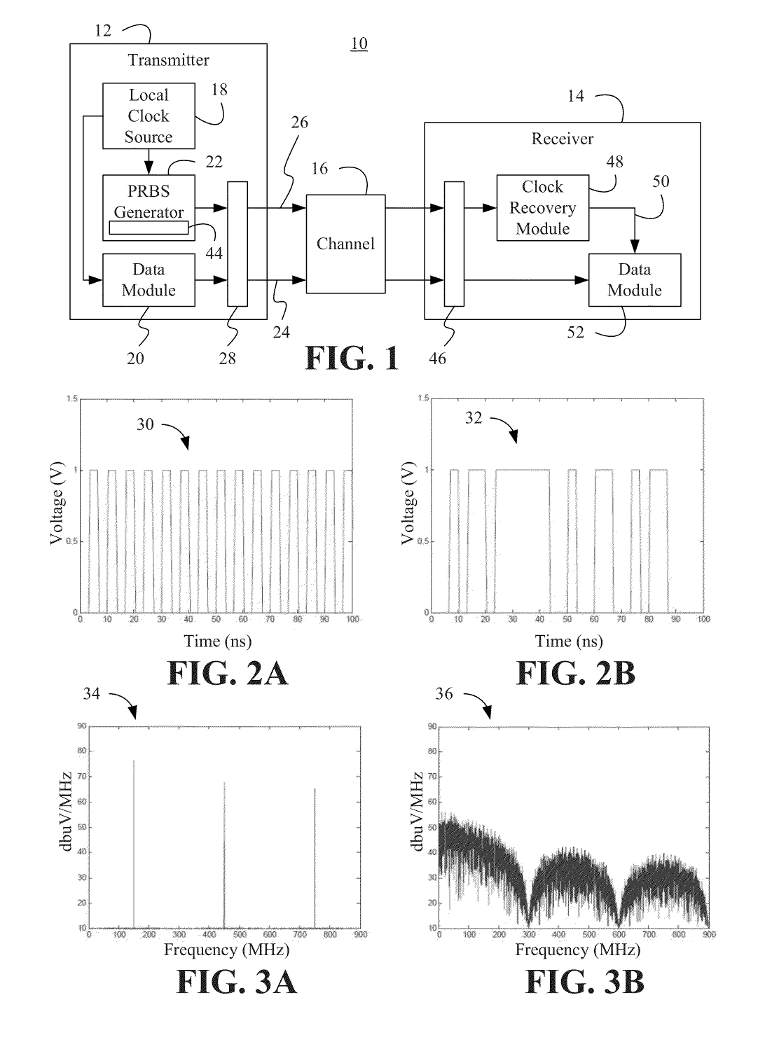

FIG. 1 shows a clock forwarding link 10 in which a transmitter 12 communicates with a receiver 14 over a channel 16. The link 10, which may be bidirectional, may generally be within a platform such as a computing platform, or across platforms such as between video components. For example, the transmitter 12 could reside on a processor such as a central processing unit (CPU) of a computing platform, wherein the receiver 14 might reside on a memory module such as DDR (dual data rate) system memory, wherein the CPU and DDR system memory may be coupled to the same motherboard. In such a case, the channel 16 may be a planar transmission line 16 such as, for example, a set of traces embedded in a printed circuit board (PCB). The transmitter 12 may also be a video component such as a set-top box (STB), cable modem, satellite receiver, personal computer (PC), smart tablet, etc., wherein the receiver 14 may be a display device such as, for example, a television (TV), monitor, smart tablet, or other device configured to synthesize clock frequencies and/or present video content to one or more users. In such a case, the channel 16 might be a cable such as an HDMI (High-Definition Multimedia Interface) cable, LVDS (Low Voltage Differential Signaling, e.g., TIA/EIA-644-A Electrical Characteristics of Low Voltage Differential Signaling (LVDS) Interface Circuits, Feb. 1, 2001, Telecommunications Industry Association) cable, DVI (digital visual interface) cable, MiPi (Mobile Industry Processor Interface, e.g., MiPi D-PHY) cable, and so forth.

The illustrated transmitter 12 includes a local clock source 18 to provide a local clock to a data module 20, wherein the data module 20 generates a data signal 24 based on the local clock signal. More particularly, the data module 20 may use timing edges in the local clock signal to produce binary content (i.e., logical ones and zeros) in the data signal 24. Of particular note is that the timing edges of the local clock signal may be a source of interference such as electromagnetic interference (EMI) and/or radio frequency interference (RFI) if transmitted on the channel 16, particularly if the frequency of the local clock signal is relatively high and the physical length of the channel 16 is relatively long. Accordingly, the local clock source 18 may also provide the local clock signal to a pseudorandom binary sequence (PRBS) generator 22, which can function as a conversion module that converts the local clock signal into a PRBS signal 26. As will be discussed in greater detail, the PRBS signal 26 may generally have timing edges that are randomized and fewer in number (per period of time) than the local clock signal, wherein the randomized and fewer timing edges can significantly reduce the likelihood of noise/interference when the PRBS signal 26 and data signal 24 are transmitted to the channel 16 via a channel interface 28 (which may be a cable interface, planar transmission line interface, and so forth).

For example, FIGS. 2A and 2B show a clock signal 30 and a corresponding PRBS signal 32, respectively, wherein the clock signal 30 is periodic and the PRBS signal 32 is randomized with fewer timing edges than the clock signal 30. FIGS. 3A and 3B show spectrum plots 34 and 36 for the clock signal 30 (FIG. 2A) and the PRBS signal 32 (FIG. 2B), respectively. In the illustrated example, the signal energy of the clock spectrum plot 34 is heavily concentrated at a few frequencies, which could cause significant EMI/RFI concerns. The signal energy of the PRBS spectrum plot 36, on the other hand, is spread across a very wide band. Moreover, the signal level in the PRBS spectrum plot 36 is reduced by at least 25 dB relative to the clock spectrum plot 34, in the example shown.

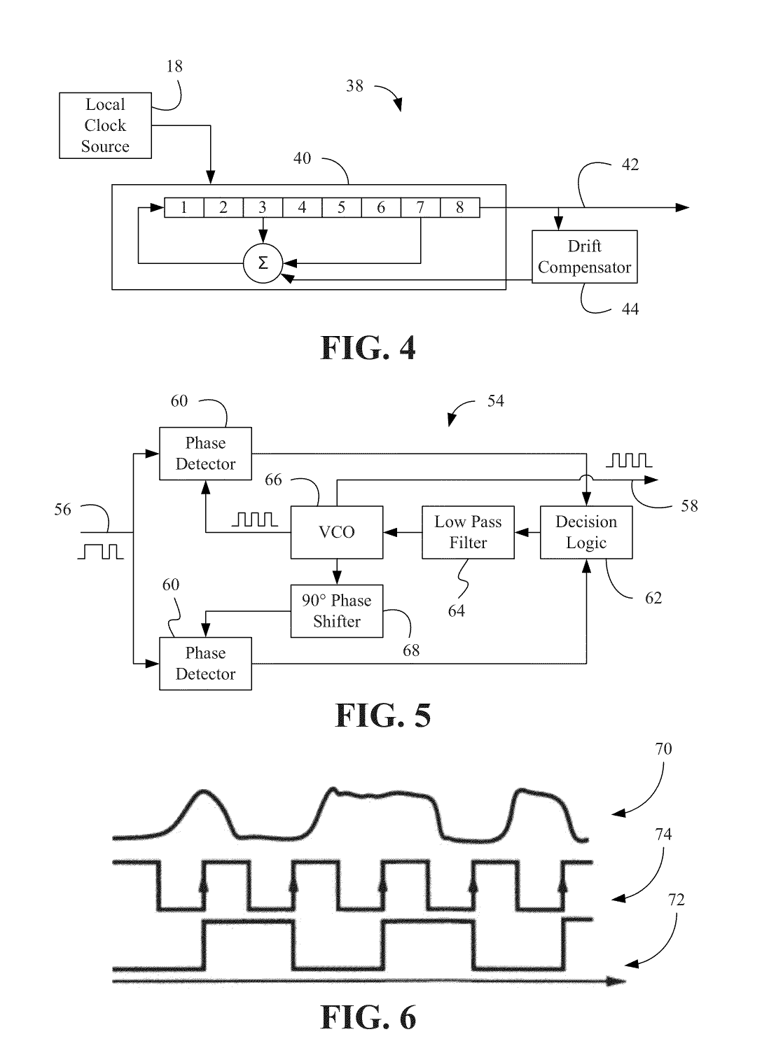

Turning now to FIG. 4, one approach to implementing a conversion module 38 is shown. Thus, the conversion module 38 may be readily substituted for the PRBS generator 22 (FIG. 1), already discussed. In the illustrated example, a linear feedback shift register (LFSR) 40 receives the local clock from the local clock source 18, and generates a PRBS signal 42. Thus, the LFSR 40 may operate at the same frequency as the local clock, wherein the PRBS signal 42 is randomized and can generally contain fewer timing edges than the local clock. Of particular note is that the PRBS signal 42 may exhibit long sequences of consecutive zeros or ones. Such long sequences may not contain timing information and could otherwise cause drift of the recovered clock signal. Accordingly, the illustrated conversion module 38 also includes a drift compensator 44 that selectively adds timing edges to the PRBS signal 42. For example, when n=7, if the PRBS signal 42 contains eight consecutive zeros, a one may be inserted after the seventh zero in order to ensure that the clock recovery circuitry does not drift too much. Another solution may be to design the receiver 14 (FIG. 1), to minimize the drift (e.g., compensate in a low pass filter), as will be discussed in greater detail. Other configurations for the conversion module 38 may include, for example, lookup tables, etc.

Returning now to FIG. 1, the illustrated receiver 14 includes a channel interface 46 (which may be a cable interface, planar transmission line interface, and so forth) to receive the data signal 24 and the PRBS signal 26 from the channel 16. A clock recovery module 48 may generate a recovered clock 50 based on the PRBS signal 26, wherein a data module 52 may process the data signal 24 based on the recovered clock 50.

FIG. 5 shows one example of a digital phase locked loop (DPLL) 54, wherein the DPLL 54 is a type of “quadricorrelator” that may generally function as a clock recovery module for a non-return-to-zero (NRZ) signal such as a PRBS signal 56. Thus, the DPLL 54 may be readily substituted for the clock recovery module 48 (FIG. 1), already discussed. In the illustrated example, the DPLL 54 recovers timing information from the PRBS signal 56 and outputs a periodic recovered clock signal 58. More particularly, a set of phase detectors 60 that is offset by ninety degrees due to a phase shifter 68 may be used to generate phase information. Each phase detector 60 may be a double-edged flip-flop with its clock node connected to the PRBS signal 56.

In the illustrated example, two phase detectors are used in order to obtain orthogonal channels so that the DPLL 54 locks onto the correct clock frequency (e.g., rather than a harmonic). Thus, the phase detectors 60 may output phase information to decision logic 62, which provides a feedback signal to a low pass filter 64 and a voltage controlled oscillator (VCO) 66. The output of the low pass filter 64 is coupled to the VCO 66 so that the VCO will match its timing edges to the PRBS signal 56. When a lock is obtained, the recovered clock signal 58 output from the VCO 66 will have the correct frequency and timing edges. The low-pass filter 64 may also be designed to minimize drift resulting from long sequences of zeros or ones in the PRBS signal 56. FIG. 6 shows an example of a PRBS signal 70, a phase detector output signal 72, and a recovered clock signal 74.

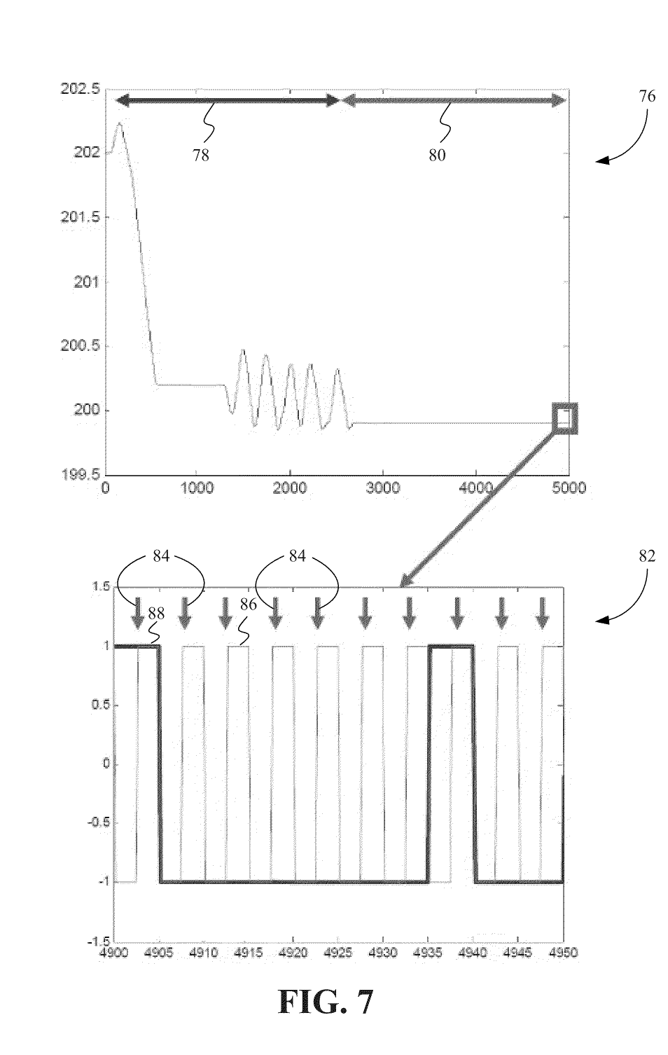

FIG. 7 shows a DPLL locking plot 76 in which the DPLL is in an “approaching” state during time period 78 as the VCO is adjusting itself to match the correct clock frequency and phase. The DPLL enters a “locked” state during time period 80 once the output of the VCO settles on the correct frequency and phase. A locked plot 82 demonstrates how the timing edges 84 of a recovered clock signal 86 may compare with a corresponding PRBS signal 88. Of particular note is that the illustrated clock signal 86 maintains a proper timing sequence for at least six consecutive zeros in the PRBS signal 88. Thus, the VCO frequency can remain stable and accurate even without timing information for extended periods of time.

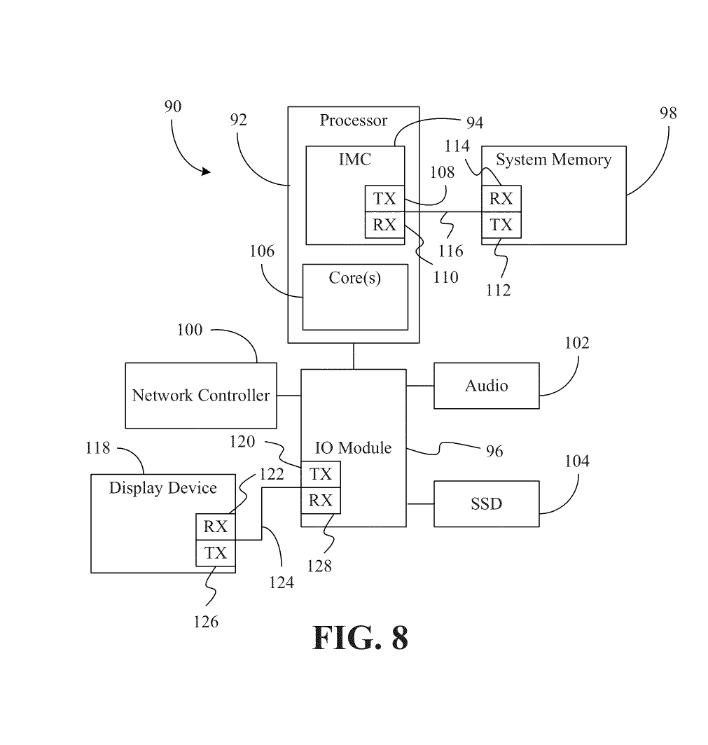

Turning now to FIG. 8, a computing platform 90 is shown. The platform 90 may be part of a mobile device having computing functionality (e.g., personal digital assistant/PDA, laptop, smart tablet), communications functionality (e.g., wireless smart phone), imaging functionality, media playing functionality (e.g., smart television/TV), or any combination thereof (e.g., mobile Internet device/MID). The platform 90 may also be part of a fixed device such as, for example, a desktop computer, workstation, set-top box, media server, and so forth. In the illustrated example, the platform 90 includes a processor 92, an integrated memory controller (IMC) 94, an input output (IO) module 96, system memory 98, a network controller 100, an audio IO device 102, a display device 118, and a solid state disk (SSD) 104. The processor 92 may include a core region with one or several processor cores 106.

The illustrated 10 module 96, sometimes referred to as a Southbridge or South Complex of a chipset, functions as a host controller and communicates with the network controller 100, which could provide off-platform communication functionality for a wide variety of purposes such as, for example, cellular telephone (e.g., Wideband Code Division Multiple Access/W-CDMA (Universal Mobile Telecommunications System/UMTS), CDMA2000 (IS-856/IS-2000), etc.), WiFi (Wireless Fidelity, e.g., Institute of Electrical and Electronics Engineers/IEEE 802.11-2007, Wireless Local Area Network/LAN Medium Access Control (MAC) and Physical Layer (PHY) Specifications), 4G LTE (Fourth Generation Long Term Evolution), Bluetooth (e.g., IEEE 802.15.1-2005, Wireless Personal Area Networks), WiMax (e.g., IEEE 802.16-2004, LAN/MAN Broadband Wireless LANS), Global Positioning System (GPS), spread spectrum (e.g., 900 MHz), and other radio frequency (RF) telephony purposes. The IO module 96 may also include one or more wireless hardware circuit blocks to support such functionality. Although the processor 92 and 10 module 96 are illustrated as separate blocks, the processor 92 and 10 module 96 may be implemented as a system on chip (SoC) on the same semiconductor die.

The system memory 98 may include, for example, double data rate (DDR) synchronous dynamic random access memory (SDRAM, e.g., DDR3 SDRAM JEDEC Standard JESD79-3C, April 2008) modules. The modules of the system memory 98 may be incorporated into a single inline memory module (SIMM), dual inline memory module (DIMM), small outline DIMM (SODIMM), and so forth. The SSD 104 may include one or more NAND (negated AND) chips and might be used to provide high capacity data storage and/or a significant amount of parallelism. There may also be solutions that include NAND controllers implemented as separate ASIC controllers being connected to the IO module 64 on standard buses such as a Serial ATA (SATA, e.g., SATA Rev. 3.0 Specification, May 27, 2009, SATA International Organization/SATA-IO) bus, or a PCI Express Graphics (PEG, e.g., Peripheral Components Interconnect/PCI Express x16 Graphics 150W-ATX Specification 1.0, PCI Special Interest Group) bus. The SSD 104 could also be used as a USB (Universal Serial Bus, e.g., USB Specification 3.0, USB Implementers Forum) flash storage device.

The illustrated IMC 94 includes a transmitter 108 configured to transmit data signals and PRBS signals to a receiver 114 of the system memory 98 over a planar transmission line 116, wherein the PRBS signals are generated based on a local clock of the IMC 94. The receiver 114 may generate recovered clock signals based on the PRBS signals. Similarly, the system memory 98 may include a transmitter 112 to transmit data signals and PRBS signals to a receiver 110 of the IMC over the planar transmission line 116. The receiver 110 may also generate recovered clock signals based on the PRBS signals. Using PRBS signals rather than periodic clock signals may significantly reduce EMI and RFI within the platform 90 and between the platform 90 and other platforms (not shown), as already discussed. The illustrated approach may also enable a reduction of interference mitigation components, which can reduce cost and manufacturing time.

The IO module 96 may also include a transmitter 120 configured to transmit data signals and PRBS signals to a receiver 122 of the display device 118 over a cable 124, such as an HDMI cable. The PRBS signals may be generated based on a local clock of the IO module 96, wherein the receiver 122 may generate recovered clock signals based on the PRBS signals. Similarly, the display device 118 may include a transmitter 126 to transmit data signals and PRBS signals to a receiver 128 of the IO module 96 over the cable 124. The receiver 128 may also generate recovered clock signals based on the PRBS signals. Of particular note is that the cable 124 may be relatively long, which can make it particularly suitable for use with the PRBS clock forwarding techniques described herein. The display device 118 may also communicate with the platform via a graphics processing unit (GPU) or other dedicated graphics hardware.

Thus, techniques described herein may therefore provide a low cost solution to mitigating EMI/RFI noise caused by clock forwarding. Simple circuit blocks may be employed to generate and recover low noise profile clock signals. Moreover, complexity can be reduced relative to embedded clocking schemes, since bit coding, training sequences and idle sequences are no longer required. The techniques described herein may also be combined with other mitigation techniques to further reduce EMI/RFI noise.

Embodiments of the present invention are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. are used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A system comprising:
a channel;
a transmitter including,
a first data module to generate a data signal based on a local clock signal,
a conversion module to convert the local clock signal into a pseudorandom binary sequence (PRBS) signal, and
a first channel interface to send the data signal and the PRBS signal via the channel; and
a receiver including,
a second channel interface to receive the data signal and the PRBS signal from the channel,
a clock recovery module to generate a recovered clock based on the PRBS signal, and
a second data module to process the data signal based on the recovered clock.

2. The system of claim 1, wherein the PRBS signal is to have a number of timing edges that is randomized and less than a number of timing edges in the local clock signal per period of time.

3. The system of claim 1, wherein the conversion module includes a drift compensator to add one or more timing edges to the PRBS signal.

4. The system of claim 1, wherein the conversion module includes one or more of a linear feedback shift register and a lookup table.

5. The system of claim 1, wherein the transmitter further includes a local clock source to generate the local clock signal.

6. The system of claim 1, wherein the clock recovery module includes a digital phase-locked loop (DPLL).

7. The system of claim 6, wherein the DPLL includes:
a phase detector coupled to the second channel interface;
a low pass filter; and
a voltage controlled oscillator coupled to the phase detector and the low pass filter.

8. The system of claim 1, wherein the transmitter and receiver include video components and the channel includes a cable.

9. The system of claim 8, wherein the transmitter and receiver reside on separate platforms.

10. The system of claim 1, wherein the transmitter includes a processor, the receiver includes a memory module, and the channel includes a planar transmission line.

11. A method comprising:
generating a data signal based on a local clock signal;
converting the local clock signal into a pseudorandom binary sequence (PRBS) signal;
transferring the data signal and the PRBS signal from a transmitter to a receiver via a channel;
generating a recovered clock signal at the receiver based on the PRBS signal; and
processing the data signal based on the recovered clock signal.

12. The method of claim 11, wherein the PRBS signal has a number of timing edges that is randomized and less than a number of timing edges in the local clock signal per period of time.

13. The method of claim 11, further including adding one or more timing edges to the PRBS signal.

14. The method of claim 11, wherein the data signal and the PRBS signal are transferred over one of a cable and a planar transmission line.

15. A transmitter comprising:
a data module to generate a data signal based on a local clock signal;
a conversion module to convert the local clock signal into a pseudorandom binary sequence (PRBS) signal; and
a channel interface to send the data signal and the PRBS signal to a receiver via a channel.

16. The transmitter of claim 15, wherein the PRBS signal is to have a number of timing edges that is randomized and less than a number of timing edges in the local clock signal per period of time.

17. The transmitter of claim 15, wherein the conversion module includes a drift compensator to add one or more timing edges to the PRBS signal.

18. The transmitter of claim 15, wherein the conversion module includes a linear feedback shift register.

19. The transmitter of claim 15, wherein the conversion module includes a lookup table.

20. The transmitter of claim 15, wherein the channel interface is a cable interface.

21. The transmitter of claim 15, wherein the channel interface is a planar transmission line interface.

22. The transmitter of claim 15, further including a local clock source to generate the local clock signal.

23. A receiver comprising:
a channel interface to receive a data signal and a pseudorandom binary sequence (PRBS) signal from a channel;
a clock recovery module to generate a recovered clock based on the PRBS signal; and
a data module to process the data signal based on the recovered clock.

24. The receiver of claim 23, wherein the PRBS signal is to have a number of timing edges that is randomized and less than a number of timing edges in the local clock signal per period of time.

25. The receiver of claim 23, wherein the clock recovery module includes a digital phase-locked loop (DPLL).

26. The receiver of claim 25, wherein the DPLL includes:
a phase detector coupled to the channel interface;
a low pass filter; and
a voltage controlled oscillator coupled to the phase detector and the low pass filter.

27. The receiver of claim 23, wherein the channel interface includes a cable interface.

28. The receiver of claim 23, wherein the channel interface includes a planar transmission line interface.
